(19) United States
(12) Patent Application Publication
(10) Pub. No.: US 2009/0128522 A1
(43) Pub. Date: May 21, 2009

(54) STYLUS USED TO OPERATE ON TOUCH SCREEN

(75) Inventor: CHIEN-CHIH CHEN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/967,051

(22) Filed: Dec. 29, 2007

(30) Foreign Application Priority Data
Nov. 15, 2007 (CN) 200710202557.3

(51) Int. Cl. G06F 3/033

(52) U.S. Cl. 345/179

(57) ABSTRACT

A stylus (20) includes a main member (21), a resilient member (22), a pressing member (24) and a barrel member (25). The barrel member is fixed on the main member. The pressing member is movably received in the barrel member and extends out of the barrel member. The resilient member is received in the barrel member and positioned between the main member and the pressing member.

### BACKGROUND OF THE INVENTION

1. Field of the Invention

The present invention generally relates to a stylus used to operate on touch screens, and particularly to a resilient stylus used to operate on touch screens.

2. Description of Related Art

Nowadays, many portable electronic devices, such as mobile phones and personal digital assistants (PDAs), can be operated via touch screens and corresponding styluses. In use, one end of a stylus is used to press a touch screen of a portable electronic device so as to input instruction. Thus, typical keypads of the portable electronic device can be omitted, and the portable electronic devices can be conveniently operated.

However, when a typical stylus is pressed on a touch screen of a portable electronic device, it is difficult for a user to precisely feel strength of the pressure applied on the touch screen. In this way, the touch screen may be damaged by excessive strength of the user.

Therefore, a new stylus is desired in order to overcome the above-described shortcomings.

### SUMMARY

A stylus includes a main member, a resilient member, a pressing member and a barrel member. The barrel member is fixed on the main member. The pressing member is movably received in the barrel member and extends out of the barrel member. The resilient member is received in the barrel member and positioned between the main member and the pressing member.

Other novel features will become more apparent from the following detailed description when taken in conjunction with the accompanying drawings.

### BRIEF DESCRIPTION OF THE DRAWINGS

Many aspects of the stylus can be better understood with reference to the following drawings. The components in the drawings are not necessarily drawn to scale, the emphasis instead being placed upon clearly illustrating the principles of the stylus. Moreover, in the drawings, like reference numerals designate corresponding parts throughout the several views.

FIG. 1 is an exploded view of a stylus in accordance with a present embodiment.

FIG. 2 is similar to FIG. 1, but shown in another visual angle.

FIG. 3 is an assembled view of the stylus shown in FIG. 1.

FIG. 4 is an enlarged, cross-sectional view of the stylus shown in FIG. 3.

### DETAILED DESCRIPTION OF THE INVENTION

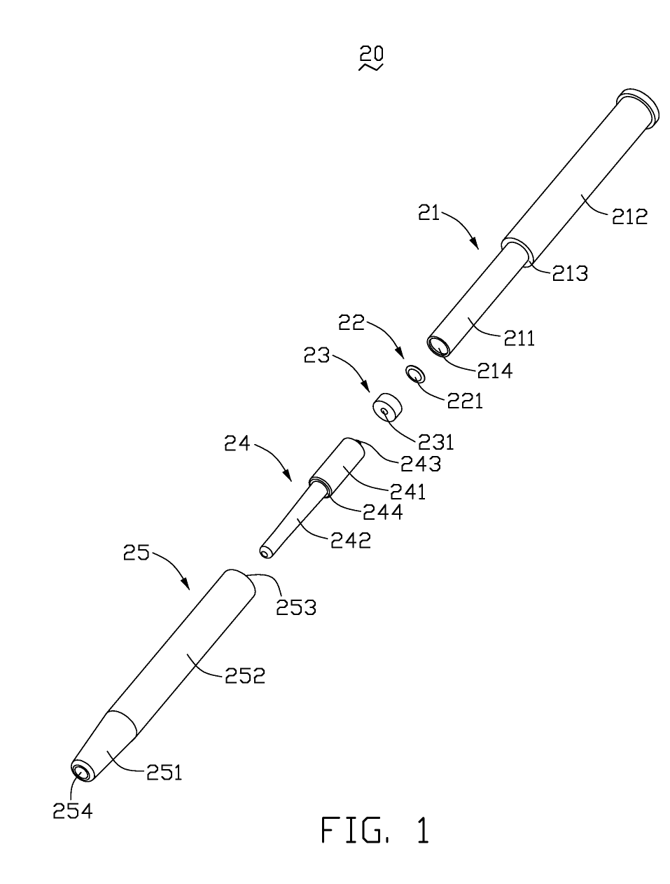

Referring to FIG. 1, a stylus 20 in accordance with a present embodiment is provided. The stylus 20 is used as an input device to press a touch screen of a portable electronic device. The stylus 20 includes a main member 21, a resilient member 22, a cushion member 23, a pressing member 24 and a barrel member 25. The pressing member 24, the cushion member 23 and the resilient member 22 are to be received in the barrel member 25, and are to be latched by the main member 21 after an assembly procedure, as will be described in more detailed.

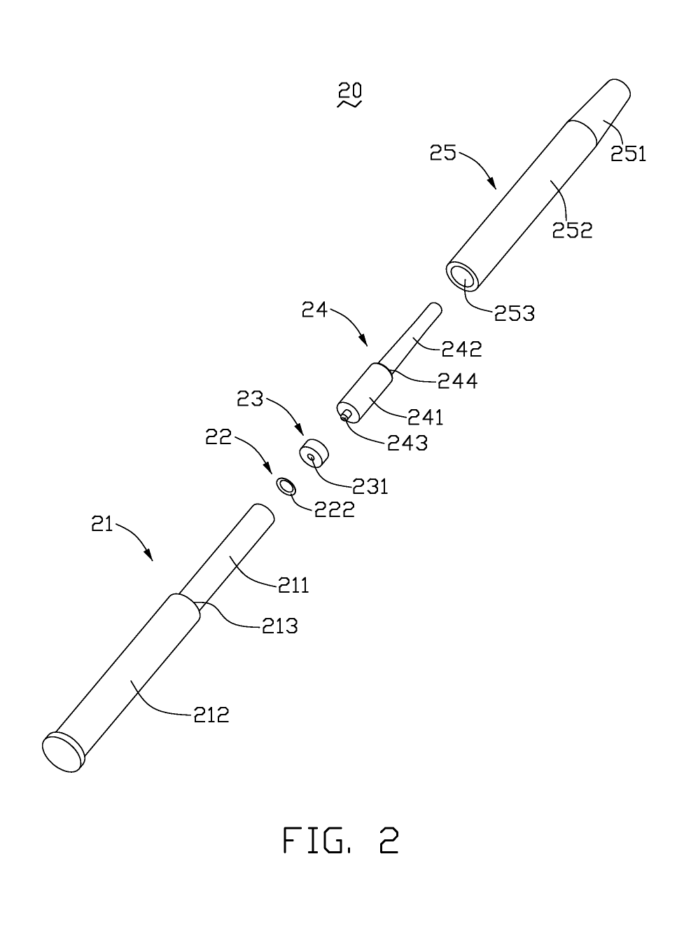

Also referring to FIG. 2, the main member 21 is made of plastics, such as ABS (Acrylonitrile Butadiene Styrene) or PC (Polycarbonate), and includes a first cylinder 211 and a second cylinder 212. One end of the second cylinder 212 is coaxially connected to the first cylinder 211. A diameter of the first cylinder 211 is less than that of the second cylinder 212, thus a stepped surface 213 is formed on an end of the second cylinder 212 which is connected to the first cylinder 211. The first cylinder 211 defines a round groove 214 at one free end thereof for receiving the resilient member 22.

The resilient member 22 is a resilient round sheet, which is configured to be a partial spherical surface, and a convex surface 221 and a concave surface 222 corresponding to the convex surface 221 are respectively formed on two opposite sides of the resilient member 22. The resilient member 22 is configured and sized to be fit into the round groove 214.

The cushion member 23 is a cylinder with a receiving hole 231 coaxially defined therethrough. The cushion member 23 is made of resilient material, such as rubber. In this way, the cushion member 23 can be used to fill unwanted space in the stylus 20 to prevent unwanted movement of any component of the stylus 20, and absorb impacts generated in the stylus 20.

The pressing member 24 is made of plastics, such as ABS or PC, and includes a head portion 241, a tail portion 242 connected to one end of the head portion 241 and a protrusion 243 formed on the other end of the head portion 241. The head portion 241 is a cylinder, and has a same diameter as that of the first cylinder 211. The tail portion 242 is a cylinder coaxially connected to the head portion 241. A diameter of the tail portion 242 is less than that of the head portion 241, thus an annular first blocking surface 244 is formed on an end of the head portion 241 and connected to the tail portion 242. The protrusion 243 is a cylinder sized to fit in the receiving hole 231 of the cushion member 23.

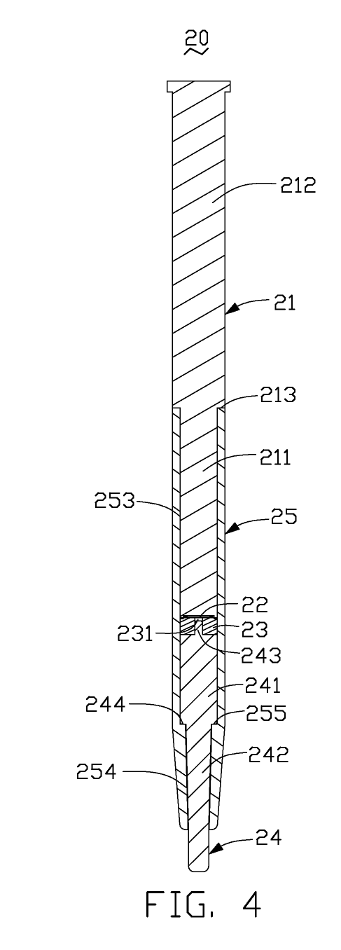

The barrel member 25 is made of plastics, such as ABS or PC, and includes a conic portion 251 and a cylindrical portion 252 coaxially connected to a bottom of the conic portion 251. The cylindrical portion 252 defines a first latched hole 253 configured for receiving the first cylinder 211 and the head portion 241. The conic portion 251 defines a second latched hole 254 configured for receiving the tail portion 242 and coaxially communicating with the first latched hole 253 therethrough. Also referring to FIG. 4, a diameter of the second latched hole 254 is less than that of the first latched hole 253, thereby an annular second blocking surface 255 is formed therein on a joint between the conic portion 251 and the cylindrical portion 252. A depth of the second latched hole 254 is configured to be less than a length of the tail portion 242, so the tail portion 242 has a portion extending from the second latched hole 254.

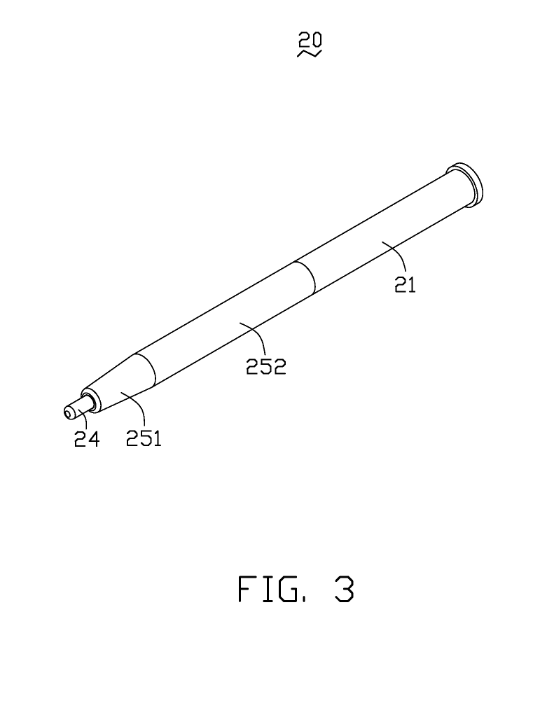

Also referring to FIG. 1 and FIG. 3, in assembly, the pressing member 24 is inserted into the first latched hole 253. The tail portion 242 is received and engaged in the second latched hole 254, and the head portion 241 is received and engaged in the first latched hole 253. The first blocking surface 244 and the second blocking surface 255 resist each other to prevent the pressing member 24 from falling out of the barrel member 25. Since a depth of the second latched hole 254 is less than a length of the tail portion 242, one end of the tail portion 242 extends out of the second latched hole 254. The cushion member 23 is placed into the first latched hole 253 and blocked by an end of the head portion 241, and the protrusion 243 is received in the receiving hole 231. The resilient member 22 is then received in the round groove 214 of the main member 21.

The main member 21 is inserted into the first latched hole 253 and is pushed along to slide in the first latched hole 253, until the stepped surface 213 thereof contacts one end of the barrel member 25. Finally, the barrel member 25 is fixed on the stepped surface 213 of the main member 21 via glue or soldering. In this way, the first cylinder 211 is received in the first latched hole 253, and the pressing member 24, the cushion member 23 and the resilient member 22 are received in the barrel member 25. The resilient member 22 and the cushion member 33 are positioned between the pressing member 24 and the main member 21, with the protrusion 243 of the pressing member 24 being proximate to the resilient member 22.

In use, the tail portion 242 of the pressing member 24 is used as an input device to press a touch screen (not shown). When the tail portion 242 is pressed, the pressing member 24 is pushed to move towards the main member 21. The cushion member 23 is then compressed to absorb impacts generated between the pressing member 24 and the main member 21, and the protrusion 243 is pushed to press the resilient member 22 via the receiving hole 231 until the protrusion 243 and the resilient member 22 are blocked by the bottom of the round groove 214. In this way, the pressing member 24 is prevented from impacting hard components, such as the main member 21. After the user release the tail portion 242 of the pressing member 24, the resilient member 22 and the cushion member 23 resile to push the pressing member 24 to an initial position, thus the stylus 20 can be used again.

Additionally, the first cylinder 211 can also be threadingly engaged with the barrel member 25. The resilient member 22 can also configured to be a spring.

Understandably, the resilient member 22 and the cushion member 33 positioned between the pressing member 24 and the main member 21 may improve an operating handle of using the stylus 20 and prevent the pressing member 24 from impacting the main member 21. Compared with typical styluses, the stylus 20 is used more facilely, and the pressing member 24 is well protected.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A stylus, comprising:
a main member;
a barrel member fixed on the main member;
a pressing member movably received in the barrel member and extending out of the barrel member; and
a resilient member received in the barrel member and positioned between the main member and the pressing member.

2. The stylus as claimed in claim 1, wherein the main member includes a first cylinder and a second cylinder coaxially connected to the first cylinder, a diameter of the first cylinder being less than that of the second cylinder.

3. The stylus as claimed in claim 2, wherein the first cylinder defines a round groove configured for receiving the resilient member therein.

4. The stylus as claimed in claim 2, wherein the barrel member defines a first latched hole therein, the first cylinder being received in the first latched hole.

5. The stylus as claimed in claim 1, wherein the pressing member includes a cylindrical head portion and a cylindrical tail portion coaxially connected to the head portion.

6. The stylus as claimed in claim 5, wherein the barrel member defines a second latched hole therein, the tail portion engaging in the second latched hole and extending out of the second latched hole.

7. The stylus as claimed in claim 1, wherein the main member includes a stepped surface configured to fix the barrel member thereon.

8. The stylus as claimed in claim 1, wherein the pressing member includes a first blocking surface and the barrel member includes a second blocking surface, the first blocking surface and the second blocking surface resist each other to prevent the pressing member from falling out of the barrel member.

9. The stylus as claimed in claim 1, wherein the pressing member includes a protrusion formed thereon and positioned proximate to the resilient member.

10. The stylus as claimed in claim 9, further comprising a cushion member received in the barrel member and positioned between the main member and the pressing member.

11. The stylus as claimed in claim 10, wherein the cushion member defines a receiving hole configured for receiving the protrusion of the pressing member therein.
